(19) United States
(12) Patent Application Publication
(10) Pub. No.: US 2019/0055915 A1
(43) Pub. Date: Feb. 21, 2019

(54) MACHINE GENERATOR WITH CYCLICAL, VERTICAL MASS TRANSPORT MECHANISM

(71) Applicant: Ernest William Townsend, IV, Scottsdale, AZ (US)

(72) Inventor: Ernest William Townsend, IV, Scottsdale, AZ (US)

(21) Appl. No.: 15/677,800

(22) Filed: Aug. 15, 2017

(51) Int. Cl. F03B 17/04

(52) U.S. Cl. CPC F03B 17/04; F03G 3/00

(57) ABSTRACT

A machine is provided for recycling a buoyant module, to convert potential energy of the module into kinetic energy, and to then restore potential energy for the module in another cycle. To do this, the machine requires a bi-level water tank that includes a transfer tank having a lower level water surface and a return tank having an upper level water surface. A two-valve mechanism operates during each cycle to effectively maintain these respective water levels. During a gravity phase in the cycle, the module is dropped from a launch point above the tank to develop kinetic energy for work. After this work is done, the module enters the transfer tank and decelerates. In a buoyancy phase of the cycle, the submerged module is propelled, by its buoyancy, from the transfer tank and through the return tank to the original launch point for another cycle.

### FIELD OF THE INVENTION

The present invention pertains generally to machines for running electric generators. More particularly, the present invention pertains to machines that run electric generators by converting the potential energy of an object into kinetic energy for use in running the electric generator, as the object falls under the influence of gravity. The present invention is particularly, but not exclusively, useful for machines that use a body of liquid (e.g. water) to dissipate the kinetic energy of an object, and then use the buoyant force that is exerted by the liquid against the object to return it to a launch point for subsequently generating kinetic energy for the object to do further work in another duty cycle.

### BACKGROUND OF THE INVENTION

From an engineering perspective, the present invention requires a general familiarity with the concepts of work and energy, and their interrelationship with each other. In particular, the present invention is concerned with the work-energy relationship of a moving object.

By definition, the work, U, that is done by a force, F, when moving an object from one location (position) to another, is equal to the product of the force, F, and the displacement, dr, of the object. Mathematically, work is expressed as:

U=Fdr

On the other hand, the kinetic energy, T, of an object in motion (i.e. its capacity to do work as a moving object) is mathematically expressed as:

T=½mv²

where m is the mass of the object and vis its velocity at a point in time.

In accordance with the general principle of work and energy, it can be shown that as an object moves under the influence of a force F through a displacement dr, the kinetic energy T of the object will be changed by the work U done on or by the object. Mathematically:

T₁+U_{1→2}=T₂

Stated differently, the kinetic energy at a first position, T₁, plus the work required to move the object from the first position to a second position, U_{1→2}, is equal to the kinetic energy of the object at the second position, T₂.

With the above relationships in mind, it Is also helpful to know that the energy of a body can be expressed either as potential energy or kinetic energy. The distinction here is that an object has potential energy by virtue of its position or configuration (i.e. static), whereas it has kinetic energy by virtue of its motion (dynamic). The present invention incorporates considerations of both types of energy in two different contexts.

Along with a consideration of energy in the context of an object falling under the force of gravity, the present invention is also concerned with the energy of an object in a context wherein the object is submerged in a liquid (e.g. water). In this latter context, a buoyant force will act on the submerged object that is equal to the weight of the liquid that is displaced by the object. Though the contexts are different, the force of gravity and a buoyant force will have similar dynamic effects on an object, insofar as the work-energy relationship is concerned.

In overview, as envisioned for a duty cycle of the present invention, the force of gravity will convert the potential energy of an object into kinetic energy as the object falls from a predetermined height into a liquid tank. Part of the object's kinetic energy during its fall will then be used to do work in operating an electric generator for generating electricity. Subsequently, a buoyant force acting on the object in the liquid tank will give the object sufficient kinetic energy to return the object to the position of height from which it was originally dropped.

In light of the above, it is an object of the present invention to provide a machine that converts the kinetic energy of a falling object into work for the operation of an electric generator. Still another object of the present invention is to provide a machine that creates a buoyant force on an object that will generate sufficient kinetic energy for the object to return it to a predetermined height. Yet another object of the present invention is to provide a machine with a valve mechanism for a liquid tank that reconfigures the tank to alternately provide a low pressure head, h₁, and a high pressure head, h₂, in the same liquid tank. Another object of the present invention is to provide a machine for generating electrical energy that is easy to use, is relatively simple to install, and is competitively cost effective.

### SUMMARY OF THE INVENTION

In accordance with the present invention, a machine for operating an electric generator incorporates five groups of components. These groups are: i) a bi-level liquid (e.g. water) tank having both a lower level liquid surface, and a higher level liquid surface; ii) a valve mechanism, included with the bi-level tank, for maintaining the higher level liquid surface above the lower level liquid surface; iii) a module falling under the force of gravity for transferring energy from the module into work for operating the electric generator; iv) a displacement device in the bi-level tank for controlling variations in the liquid surface levels; and v) a control unit for using the valve mechanism to recycle the module through the bi-level liquid tank.

Within the combination of components for the present invention, a power path is established for the module. Specifically, the power path sequentially extends from a launch point above the tank and through a fall zone where kinetic energy is generated for the module. As envisioned for the present invention, this fall zone can be variable and can be either lengthened or shortened according to the needs of the user. In the event, after the module clears the fall zone, the module then engages with the electric generator for travel through an energy transfer section on the power path. It is in this energy transfer section where kinetic energy is transferred from the module for use as work by the electric generator in the generation of electricity.

After the module leaves the power path it enters the bi-level tank through the lower level liquid surface. In the bi-level tank, the module decelerates to zero vertical velocity at a deceleration point. At the deceleration point in the tank, a transfer mechanism, which is located inside the tank for receiving the module from the power path, repositions the module. Specifically, the module is repositioned onto a return path for buoyant acceleration of the module. On the return path, the module leaves the tank through the upper level liquid surface of the tank for a return to the launch point.

In detail, the bi-level tank includes a transfer tank that is formed with an entry port and an exit port. It also includes a return tank that is mounted on the transfer tank, and positioned above the exit port of the transfer tank. In this combination, fluid communication can be selectively established between the transfer tank and the return tank through the exit port. Preferably the entry port is above the exit port. In an alternate embodiment, however, the entry port and the exit port are horizontally coplanar.

For purposes of the present invention, the valve mechanism includes an access valve which is positioned at the entry port of the transfer tank for opening and closing the entry port. The valve mechanism also includes a transfer valve that is positioned adjacent the exit port of the transfer tank for effectively opening and closing the exit port between the transfer tank and the return tank. In this combination, it is particularly important that a respective operation of the access valve and the transfer valve be coordinated in accordance with a predetermined procedure to ensure the entry port is closed whenever the exit port is open.

The essential aspect of the predetermined protocol for an operation of the valve mechanism is that a condition wherein the entry port and the exit port are simultaneously open, must be avoided. This is required because the exit port is submerged below the higher level liquid surface. Consequently, if both the entry port and exit port are open simultaneously, liquid would flow from the return tank into the transfer tank and out of the entry port from the bi-level tank. In the context of the present invention, starting from a configuration wherein the access valve is open and the transfer valve is closed, the access valve (open/close) and transfer valve (close/open) will change on only two occasions during a duty cycle of the machine for the present invention. The first is after the module enters the bi-level tank, and the second is after the module exits from the bi-level tank.

While the module is in the bi-level tank, i.e. when the entry port is closed and the exit port is open, the module decelerates and is repositioned. This is done by the transfer mechanism which includes a receiver having a first end and a second end. The transfer mechanism also includes a pivot mechanism that is mounted inside the transfer tank. In detail, the pivot mechanism is attached to the second end of the receiver and defines a pivot point for rotation of the receiver. In a first orientation, the first end of the receiver is positioned in the transfer tank below the access port for receiving the module as it enters the transfer tank. In a second orientation, the first end of the receiver is repositioned below the exit port for releasing the module from the transfer tank and into the return tank.

Additionally, also located inside the transfer tank is a displacement device which is preferably an expandable bladder. It is an important aspect of the present invention that the displacement device, when activated, will displace a volume, V_{d}, of liquid in the transfer tank that is equal to the displacement volume V_{d} of the module. With this in mind, it is also important to appreciate that prior to the module entering the transfer tank (i.e. entry port is open), the lower level liquid surface is at a distance Δ₁ below the entry port, such that the transfer tank is a volume V_{d} short of being completely full. Thus, when the module enters the transfer tank, the entry port is closed.

Continue to consider the module being in the transfer tank and the entry port closed by the access valve. Also, the exit port is now open. As the module is repositioned in the transfer tank, the displacement device is activated. In this case, the higher level liquid surface is raised by a distance Δ₂ to compensate for liquid displaced in the transfer tank by the displacement device. Consequently, when the module exits from the return tank, Δ₂ becomes zero as the higher level liquid surface returns to its original level.

After the module has travelled through the exit port, preferably immediately after the module's exit, the transfer valve closes the exit port. Then, after the transfer valve has closed the exit port, while the access valve has opened the entry port, the displacement device is deactivated and returns to its original volume prior to expansion. The consequence here is that Δ₁ is restored in the transfer tank and the bi-level tank is properly configured to receive another module.

In compliance with the above disclosure, a duty cycle for an operation of the machine of the present invention will include a sequence wherein: i) the access valve is open, the transfer valve is closed and the displacement device is deactivated as the module enters the transfer tank through the entry port; ii) the access valve is closed, the transfer valve is open and the displacement device is activated while the module is submerged in the transfer tank and is being transferred into the return tank; iii) as the module leaves the return tank for travel to the launch point, and the transfer valve is closed, the access valve is opened; and iv) the access valve remains open and the transfer valve remains closed as the displacement device is deactivated and the tank is reconfigured for the next duty cycle.

As envisioned for the present invention, the machine is capable of working at least two types of electric generators. One case is where the electric generator is an electromagnetic generator having a rotor and a stator. In this case, a gripper is attached to the module and a chain is connected with the rotor of the generator. The gripper on the module then engages with the chain to move the chain during the fall of the module along the power path. In turn, the chain rotates the rotor to generate electric power from the generator. In the other case, the electric generator is a linear electric generator, and at least one magnet is mounted on the module. For this configuration, a solenoid is positioned along the power path of the module to generate electric power as the module falls along the power path for an interaction between the moving magnet on the module and the solenoid.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a perspective view of a machine in accordance with the present invention showing its interactive components positioned relative to the duty cycle path of a module during an operation of the machine;

FIG. 2A is a cross-section of the machine as would be seen along the line 2-2 in FIG. 1 with the electric generator rotated into the cross-section plane for clarity, wherein the module has been launched for free fall from a launch point;

FIG. 2B is the machine as seen in FIG. 2A wherein the module has been repositioned in a transfer tank of the machine;

FIG. 2C is the machine as seen in FIG. 2B wherein the module has been accelerated by buoyancy for a return to the launch point and a repeat of the duty cycle; and

FIG. 3 is a chart correlating the temporal and configurational relationships of the module to other components of the machine (i.e. valve and displacement mechanisms) during a duty cycle.

### DESCRIPTION OF THE PREFERRED EMBODIMENTS

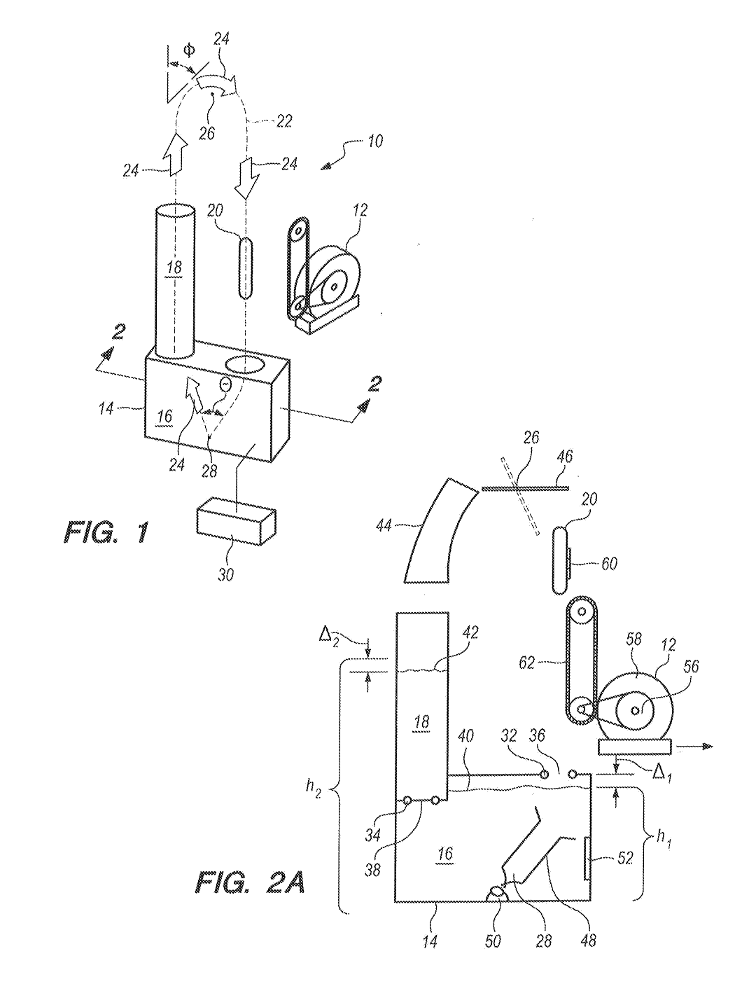

Referring initially to FIG. 1, a machine in accordance with the present invention is shown and is generally designated 10. As shown, the general purpose of the machine 10 is to provide motive forces for the operation of an electric generator 12. For this purpose, the machine 10 includes a bi-level tank 14 that includes a transfer tank 16 and a return tank 18. As intended for the present invention, a buoyant module 20 is moved by the machine 10 along a path 22 (indicated by arrows 24). In particular, the module 20 moves back and forth between a launch point 26, that is located above the bi-level tank 14, and a deceleration point 28 that is located inside the transfer tank 16. An operation of the machine 10 is directed by a control unit 30.

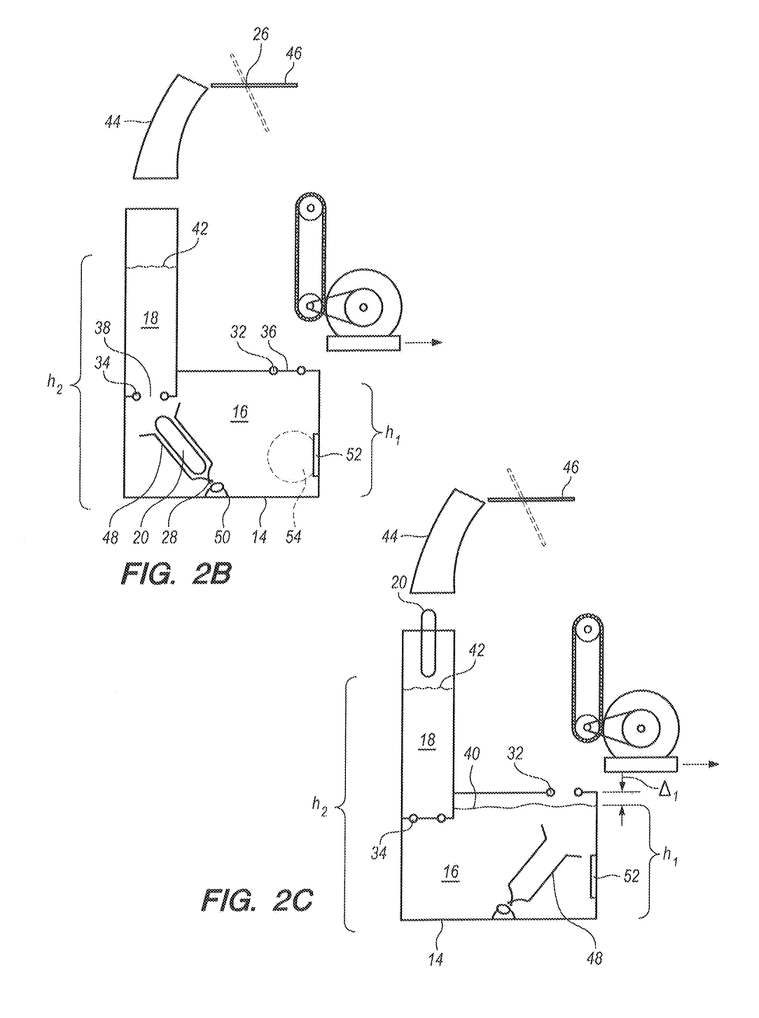

With reference to FIG. 2A, it will be seen that the bi-level tank 14 includes an access valve 32 and a transfer valve 34. Both the access valve 32 and the transfer valve 34 are connected with the control unit 30 that coordinates their cooperation and the timing for dropping a module 20 from the launch point 26. As shown, the access valve 32 is associated with an entry port 36, and it will operate to open and close the entry port 36. Similarly, the transfer valve 34 is associated with an exit port 38, and it will operate to open and close the exit port 38.

FIG. 2A also shows that the access valve 32 at the entry port 36 provides an opening into the transfer tank 16 from the external environs of the machine 10. On the other hand, the transfer valve 34 and the exit port 38 are located inside the bi-level tank 14, between the transfer tank 16 and the return tank 18. Thus, when the bi-level tank 14 is filled with a liquid (e.g. water) the transfer valve 34 and the exit port 38 will be submerged in the liquid. With this in mind, it is an important feature of the present invention that the condition is to be avoided wherein the access valve 32 and the transfer valve 34 are open at the same time. More specifically, when the access valve 32 (i.e. entry port 36) is open, the transfer valve 34 (i.e. exit port 38) must be closed.

In FIG. 2A, the machine 10 is shown in a configuration wherein the access valve 32 has opened the entry port 36, and the transfer valve 34 has closed the exit port 38. In this configuration, it is to be noted that liquid in the transfer tank 16 of the bi-level tank 14 is at a lower surface level 40 than is liquid in the return tank 18 at a higher surface level 42. Also, it is to be noted that there is a displacement Δ₁ between the lower level liquid surface 40 and the entry port 36 and that the lower level liquid surface 40 is at a pressure head, h₁. Additional structural features of the machine 10 shown in FIG. 2A include a deflector/exit chute 44 which will eventually guide the module 20 through an angle φ (see FIG. 1) onto a launch pad 46 at the launch point 26, at the end of a duty cycle.

Proceeding now to FIG. 2B, another configuration for the machine 10 is shown wherein the entry port 36 has been closed and the exit port 38 opened. Specifically, this configuration is established only after the module 20 has completely entered the transfer tank 16. Also, in FIG. 2B it is shown that after entering the transfer tank 16, the module 20 is caught by a receiver 48 and it is rotated with the receiver 48 through an angle θ (see FIG. 1) by a pivot mechanism 50 to reposition the module 20 in the transfer tank 16. FIG. 2B also shows that a displacement device 52 is positioned in the transfer tank 16. Preferably, the displacement device 52 includes an expandable bladder 54.

By cross referencing FIG. 2B with FIG. 2A, it will be seen that once the module 20 is submerged in the transfer tank 16, the displacement distance Δ₁effectively goes to zero. Also, FIG. 2B indicates that the displacement device 52 has been activated to expand the bladder 54. At this point, three different actions have taken place that are related to the displacement volume V_{d} of the module 20. For one, because the fluid volume in the transfer tank 16, which is above the lower surface level 40 equals V_{d} (i.e. V_{d} is proportional to displacement distance Δ₁), the transfer tank 16 is completely filled with liquid. For another, when the displacement device 52 is activated to expand the bladder 54, a volume of liquid is displaced in the transfer tank 16 that is equal to V_{d}. This causes the higher level liquid surface 42 to rise in the return tank 18 through a displacement distance Δ₂ to establish a pressure head, h₂.

For the configuration of the bi-level tank 14 shown in FIG. 2C, the exit port 38 is closed and the entry port 36 is opened after the module 20 passes through the exit port 38. Specifically, this configuration is established only after the module 20 has been ejected from the return tank 18. It is also to be noted in FIG. 2C, that the lower level liquid surface 40 in transfer tank 16 has receded back to where it was in FIG. 2A (i.e. Δ₁ is restored) because the displacement device 52 has been deactivated. Also, the higher level liquid surface 42 in return tank 18 has receded back to where it was in FIG. 2A because the module 20 has exited from the return tank 18. As intended for the present invention, after leaving the return tank 18, the module 20 will be returned to the launch pad 46 for its next duty cycle.

As envisioned for the present invention, the machine 10 is capable of working two types of electric generators 12. For one, the electric generator 12 can be an electromagnetic generator of a type well known in the pertinent art having a rotor 56 and a stator 58. For this type of electric generator 12, a gripper 60 is attached to the module 20 and a chain drive 62 is connected with the rotor 56 of the generator 12. The gripper 60 on the module 20 then engages with the chain drive 62 to move the chain drive 62 during the fall of the module 20 along the path 22. In turn, the chain drive 62 rotates the rotor 56 to generate electric power from the generator 12. In the other case, the electric generator 12 is a linear electric generator of a type well known in the pertinent art, and at least one magnet (not shown) is mounted on the module 20. A solenoid (also not shown) is positioned along the path 22 of the module to generate electric power as the module 20 falls along the path 22 for an interaction between the moving magnet on the module 20 and the solenoid.

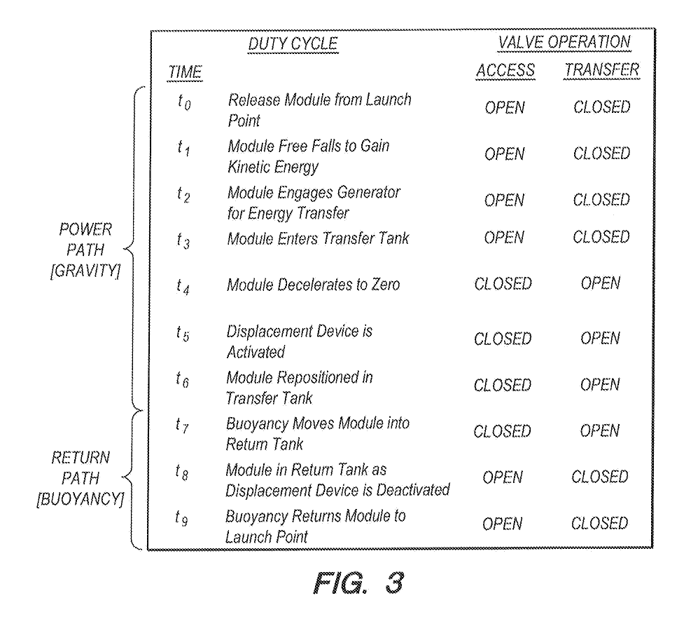

An operation of the present invention will be further appreciated with reference to FIG. 3, and with an appreciation of the fact that the control unit 30 coordinates several aspects of the machine 10 during a duty cycle. In detail, the control unit 30 coordinates the following:
Releases the module 20 at the time to from the launch point 26 to begin a duty cycle;
Changes configurations of access valve 32 and transfer valve 34 between time t₃ and t₄;
Activates the displacement device 52 at time t₅;
Moves pivot mechanism 50 to reposition submerged module 20 at time t₆;
Changes configurations of access valve 32 and transfer valve 34 between time t₇ and t₈; and
Deactivates the displacement device 52 at time t₈.

While the particular Machine Generator with Cyclical, Vertical Mass Transport Mechanism as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. A machine for running an electric generator which comprises:
a buoyant module;
a tank for holding a liquid having an upper level liquid surface and a lower level liquid surface;
a valve mechanism mounted on the tank for maintaining the upper level liquid surface above the lower level liquid surface;
a power path for the module, wherein the power path extends from a launch point above the tank and through a fall zone where kinetic energy is generated for the module, and then through an energy transfer section on the power path where kinetic energy is transferred from the module to the electric generator before the module enters the tank through the lower level liquid surface and decelerates in the tank at a deceleration point;
a return path for the module extending from the deceleration point in the tank to the launch point; and
a transfer mechanism located inside the tank for receiving the module from the power path and positioning the module onto the return path for buoyant acceleration of the module from the tank through the upper level liquid surface of the tank and a return to the launch point.

2. The machine recited in claim 1 wherein the tank comprises:
a transfer tank formed with an entry port and an exit port; and
a return tank mounted on the transfer tank and positioned above the exit port of the transfer tank for controlled fluid communication between the transfer tank and the return tank through the exit port.

3. The machine recited in claim 2, wherein the entry port and the exit port are horizontally coplanar.

4. The machine recited in claim 2 wherein the entry port is above the exit port.

5. The machine recited in claim 2 wherein the valve mechanism comprises:
an access valve positioned at the entry port on the tank for opening and closing the entry port of the transfer tank;
a transfer valve positioned at the exit port for opening and closing the exit port between the transfer tank and the return tank; and
a control unit for coordinating a respective operation of the access valve and the transfer valve in accordance with a predetermined procedure to insure the access valve is closed whenever the transfer valve is open.

6. The machine recited in claim 2 wherein the module has a displacement volume V_{d}, and the machine further comprises a displacement device mounted inside the transfer tank, wherein an activation of the displacement device displaces a volume V_{d} of liquid in the transfer tank.

7. The machine recited in claim 6 wherein the displacement device is an expandable bladder.

8. The machine recited in claim 5 wherein the control unit interacts with the access valve and the transfer valve in accordance with the predetermined procedure to establish a duty cycle wherein: i) the access valve is open, the transfer valve is closed and the displacement device is deactivated as the module enters the transfer tank through the entry port; ii) the access valve is closed, the transfer valve is opened and the displacement device is activated while the module is submerged in the transfer tank and is being transferred into the return tank; iii) as the module leaves the return tank for travel to the launch point, the access valve is opened and the transfer valve is closed; and iv) the access valve remains open and the transfer valve remains closed as the displacement device is deactivated and the tank is reconfigured for the next duty cycle.

9. The machine recited in claim 1 wherein the transfer mechanism comprises:
a receiver having a first end and a second end; and
a pivot mechanism mounted inside the transfer tank, wherein the pivot mechanism defines a pivot point and is attached to the second end of the receiver for rotating the receiver around the pivot point between a first orientation wherein the first end of the receiver is positioned in the transfer tank below the access port for receiving the module as it enters the transfer tank, and a second orientation wherein the first end of the receiver is repositioned below the exit port for releasing the module from the transfer tank and into the return tank.

10. The machine recited in claim 1 wherein the electric generator is an electromagnetic generator having a rotor and a stator, and the engagement means comprises:
a gripper attached to the module; and
a chain connected with the rotor of the generator, wherein the gripper on the module engages with the chain to move the chain during the fall of the module along the power path for rotating the rotor to generate electric power from the generator.

11. The machine recited in claim 1 wherein the electric generator is a linear electric generator and the engagement means comprises:
at least one magnet mounted on the module; and
a solenoid positioned along the power path of the module to generate electric power from the generator as the module falls along the power path for an interaction between the moving magnet and the solenoid.

12. A machine which comprises:
a bi-level liquid-filled tank including a transfer tank having a first opening and a second opening, and a return tank mounted above the transfer tank for fluid communication with the transfer tank through the second opening;
a valve mechanism having a first valve connected to the first opening, and a second valve connected to the second opening, wherein the mechanism alternately opens/closes and closes/opens the first and second valves simultaneously, to establish a first pressure head, h₁, in the transfer tank when the first valve is open and the second valve is closed, and a second pressure head, h₂, in a combined transfer tank and return tank when the first valve is closed and the second valve is open, wherein h₂ is greater than h₁ (h₂>h₁); and
a buoyant module, wherein the module is dropped from a launch point at the beginning of a duty cycle to generate kinetic energy for doing work as the module falls before the module enters the transfer tank via an open first opening, wherein h₁ is sufficient to decelerate the module in the transfer tank, and wherein the module is thereafter accelerated through an open second opening and into the return tank for exit therefrom, wherein h₂ is sufficient to propel the module to its launch point for the start of another duty cycle.

13. The machine recited in claim 12 wherein the module has a displacement volume V_{d} and the machine further comprises:
a displacement device mounted inside the transfer tank, wherein an activation of the displacement device displaces a volume V_{d} of liquid in the transfer tank; and
a control unit, wherein the control unit interacts with the first valve and the second valve in accordance with a predetermined procedure to establish a duty cycle wherein: i) the first valve is open, the second valve is closed and the displacement device is deactivated as the module enters the transfer tank through the first opening; ii) the first valve is closed, the second valve is open and the displacement device is activated while the module is submerged in the transfer tank and is being transferred into the return tank; iii) the first valve is open and the second valve is closed as the module leaves the return tank; and iv) the first valve remains open and the second valve remains closed as the displacement device is deactivated and the tank is reconfigured for the next duty cycle.

14. The machine recited in claim 13 further comprising:
a transfer mechanism including a receiver having a first end and a second end; and
a pivot mechanism mounted inside the transfer tank, wherein the pivot mechanism defines a pivot point and is attached to the second end of the receiver for rotating the receiver around the pivot point between a first orientation wherein the first end of the receiver is positioned in the transfer tank below the entry port for receiving the module as it enters the transfer tank, and a second orientation wherein the first end of the receiver is repositioned below the exit port for releasing the module from the transfer tank and into the return tank.

15. The machine recited in claim 12 further comprising:
a power path for the module, wherein the power path extends from a launch point above the tank and through a fall zone where kinetic energy is generated for the module, and then through an energy transfer section on the power path where kinetic energy is transferred from the module to an electric generator before the module enters the tank through the lower level liquid surface and decelerates in the tank at a deceleration point; and
a return path for the module extending from the deceleration point in the tank to the launch point

16. The machine recited in claim 15 wherein the electric generator is selected from the group consisting of an electromagnetic generator having a rotor and a stator, and a linear electric generator having a solenoid for interaction with a magnet mounted on the module.

17. A machine which comprises:
a bi-level, liquid-filled tank including a transfer tank having a first opening and a second opening, and a return tank mounted above the transfer tank for fluid communication with the transfer tank through the second opening;
a first valve connected to the first opening;
a second valve connected to the second opening;
a buoyant module, wherein the module is dropped from a launch point at the beginning of a duty cycle to generate kinetic energy for doing work as the module falls from the launch point and into the transfer tank via the first opening, wherein the module has a displacement volume V_{d};
a displacement device mounted inside the transfer tank, wherein an activation of the displacement device displaces the volume V_{d} of liquid in the transfer tank; and
a control unit for maintaining the duty cycle in accordance with the sequence of a predetermined procedure wherein: i) the first valve is open, the second valve is closed and the displacement device is deactivated as the module enters the transfer tank through the first opening; ii) the first valve is closed, the second valve is open and the displacement device is activated while the module is submerged in the transfer tank and is being transferred into the return tank; iii) the first valve is opened and the second valve is closed as the module leaves the return tank for travel to the launch point; and iv) the first valve remains open and the second valve remains closed as the displacement device is deactivated and the tank is reconfigured for the next duty cycle.

18. The machine recited in claim 17 wherein the duty cycle comprises:
a power path for the module, wherein the power path extends from a launch point above the tank and through a fall zone where kinetic energy is generated for the module, and then through an energy transfer section on the power path where kinetic energy is transferred from the module to an electric generator before the module enters the tank through the lower level liquid surface and decelerates in the tank at a deceleration point; and
a return path for the module extending from the deceleration point in the tank to the launch point.

19. The machine recited in claim 18 further comprising:
a transfer mechanism including a receiver having a first end and a second end; and
a pivot mechanism mounted inside the transfer tank, wherein the pivot mechanism defines a pivot point and is attached to the second end of the receiver for rotating the receiver around the pivot point between a first orientation wherein the first end of the receiver is positioned in the transfer tank below the entry port for receiving the module as it enters the transfer tank, and a second orientation wherein the first end of the receiver is repositioned below the exit port for releasing the module from the transfer tank and into the return tank.

20. The machine recited in claim 18 wherein the electric generator is selected from the group consisting of an electromagnetic generator having a rotor and a stator, and a linear electric generator having a solenoid for interaction with a magnet mounted on the module.
